(19) United States
(12) Patent Application Publication
(10) Pub. No.: US 2025/0130082 A1
(43) Pub. Date: Apr. 24, 2025

(54) Proverless Liquid Flow Measurement For Pipeline

(71) Applicant: Canada Pipeline Accessories Company, Ltd., Calgary (CA)

(72) Inventor: Blaine Sawchuk, De Winton (CA)

(73) Assignee: Canada Pipeline Accessories Company, Ltd., Calgary (CA)

(21) Appl. No.: 18/682,586

(22) PCT Filed: May 5, 2023
(86) PCT No.: PCT/CA2023/050620

§ 371 Date: Feb. 9, 2024

Related U.S. Application Data
(60) Provisional application No. 63/338,538, filed on May 5, 2022.

(51) Int. Cl. G01F 1/12; G01F 1/34; G01F 1/667

(52) U.S. Cl. CPC G01F 1/125; G01F 1/34; G01F 1/667

(57) ABSTRACT

A system for operating a flow meter in a fluid pipeline comprises at least one flow conditioner or mixer: at least one flow meter: a pair of pressure sensors or transmitters, to measure a differential pressure of the at least one flow conditioner or mixer; at least one further pressure sensor or transmitter that measures a fluid pressure in the pipeline; and at least one temperature sensor for measuring a fluid temperature in the pipeline. A method for operating the flow meter is also provided.

### CROSS REFERENCE TO RELATED APPLICATIONS

This PCT international patent application claims priority to U.S. Ser. No. 63/338,538, which was filed on 5 May 2022 in the United States Patent and Trademark Office, the entirety of which is incorporated herein by reference.

### TECHNICAL FIELD

The present invention is directed to a system and methods for operating a flow meter in a fluid pipeline without the need for at least one of a meter proving device, a viscometer, or a densitometer. In particular, the present invention applies to systems utilizing volumetric flow meters, for example, a turbine flow meter or an ultrasonic flow meter.

### BACKGROUND OF THE INVENTION

It is known to collect and process information from flow meters and/or ancillary equipment in a pipeline. Normally, an expensive meter proving device is installed. The meter proving device is used to calibrate a flow meter in a meter run against actual volumetric flow rate. If the fluid parameters and/or fluid type in the pipeline is changed, thereby impacting, for example, at least one of density, viscosity, or speed of sound, a new meter proof must be carried out at exorbitant cost. This meter proving is done numerous times, sometimes several times per shift.

Normally viscosity is not measured. Density may not be measured either. The flow meter is run against actual volumetric flow rate, which is dependent on at least one of density, viscosity, temperature, composition, or pressure (i.e., Reynolds number).

### SUMMARY OF INVENTION

The invention provides in a first system embodiment a system comprising at least one flow conditioner or mixer installed in a pipeline; at least one flow meter installed downstream from the at least one flow conditioner or mixer that measures a flow rate of a fluid in the pipeline; a pair of pressure sensors or transmitters, one pressure sensor or transmitter located at or near a first side of the least one flow conditioner or mixer, and another pressure sensor or transmitter located at or near a second side of the least one flow conditioner or mixer, thereby measuring a differential pressure of the at least one flow conditioner or mixer; at least one further pressure sensor or transmitter that measures a fluid pressure in the pipeline; and at least one temperature sensor for measuring a fluid temperature in the pipeline. The at least one flow meter is calibrated to provide k factor as a function of Reynolds number data for a plurality of fluids.

The invention provides in a second system embodiment further to any of the previous system embodiments a system in which the at least one flow meter is a turbine flow meter or an ultrasonic flow meter.

The invention provides in a third system embodiment further to any of the previous system embodiments a system that does not have a flow meter proving device.

The invention provides in a fourth system embodiment further to any of the previous system embodiments a system that does not have a viscometer.

The invention provides in a fifth system embodiment further to any of the previous system embodiments a system wherein the k factor and Reynolds number data are stored in and/or uploaded to at least one of a flow computer, SCADA equipment/computer, or a programmable logic controller (PLC).

The invention provides in a first method embodiment a method including measuring a differential pressure of a fluid on a first and on a second side of at least one flow conditioner or mixer installed in a pipeline with a pair of pressure sensors or transmitters, one pressure sensor or transmitter located at or near a first side of the least one flow conditioner or mixer, and another pressure sensor or transmitter located at or near a second side of the least one flow conditioner or mixer; measuring a temperature of the fluid with at least one temperature sensor; measuring a pressure of the fluid with a further pressure sensor or transmitter; measuring flow rate of the fluid with at least one flow meter downstream of the at least one flow conditioner or mixer, wherein the flow meter is calibrated for a plurality of fluids to obtain k factor as a function of Reynolds number data; and measuring or obtaining a density of the fluid. The at least one flow meter may be a turbine flow meter or an ultrasonic flow meter.

The invention provides in a second method embodiment further to any of the previous method embodiments a method further including converting the measured density of the fluid into actual density.

The invention provides in a third method embodiment further to any of the previous method embodiments a method further including calculating a Coefficient of Discharge for the at least one flow conditioner and obtaining or calculating a Reynolds number from the Coefficient of Discharge.

The invention provides in a fourth method embodiment further to any of the previous method embodiments a method further including obtaining a k factor from the k factor as a function of Reynolds number data; and calculating the actual volumetric flow rate using the k factor.

The invention provides in a fifth method embodiment further to any of the previous embodiments a method further including using a k-adjusted actual volumetric flow rate, recalculating the Coefficient of Discharge; calculating a second Reynolds number and obtaining a second k factor; and repeating the method until the Reynolds number and the k factor do not substantially change. The viscosity of the fluid may be calculated using the substantially non-changing Reynolds number.

The invention provides in a sixth method embodiment further to any of the previous embodiments a method further including calculating the actual flowing fluid Reynolds number based on the calculated viscosity, actual density, pipe diameter, and actual volumetric flow rate; using a k factor, correcting the actual volumetric flow rate to a Reynolds number-corrected flow rate; and repeating the method until the actual volumetric flow rate does not substantially change.

The invention provides in a seventh method embodiment further to any of the previous embodiments a method further including obtaining a density from a database or thermodynamic table comprising density as a function of temperature, pressure, and speed of sound for a plurality of hydrocarbon fluids.

It is an advantage of the present invention that a flow meter in a fluid pipeline may be operated without at least one of a meter proving device, a densitometer, a viscometer, or any combination thereof.

Given the following enabling description of the drawings, the methods and systems should become evident to a person of ordinary skill in the art.

### BRIEF DESCRIPTION OF THE FIGURES

FIG. 1 is a schematic of a system according to an embodiment of the present invention utilizing a turbine flow meter.

FIG. 2 shows a graph of experimental data of k factor as a function of Reynolds number for a flow meter for a plurality of fluids.

FIG. 3 shows a graph of experimental data of Coefficient of Discharge vs. Reynolds number for a plurality of fluids.

FIG. 4 is a schematic of a system according to an embodiment of the present invention utilizing an ultrasonic flow meter.

FIG. 5 is a schematic of a thermodynamic table according to an embodiment of the present invention for the system of FIG. 4.

### DETAILED DESCRIPTION OF THE INVENTION

The present invention is directed to a system and methods for operating a flow meter in a fluid pipeline. The system and methods may be used for any liquid flow or a liquid flow of a single-phase multicomponent fluid in a pipeline. In particular, the liquid flow may include, but is not limited to, a hydrocarbon fluid, oil, crude oil, or liquified natural gas (LNG).

In this detailed description, references to “one embodiment”, “an embodiment”, or “in embodiments” mean that the feature being referred to is included in at least one embodiment of the invention. Moreover, separate references to “one embodiment”, “an embodiment”, or “in embodiments” do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

As used herein “substantially”, “generally”, “about”, and other words of degree are relative modifiers intended to indicate permissible variation from the characteristic so modified (e.g., +0.1%, +0.5%, +1.0%, +2%, +5%, +10%, +20%). It is not intended to be limited to the absolute value or characteristic which it modifies but rather possessing more of the physical or functional characteristic than its opposite, and preferably, approaching or approximating such a physical or functional characteristic.

According to the present invention, a flow meter is used in a pipeline. The flow meter is calibrated against Reynolds number, for example at a calibration facility, for a plurality of fluids. As discussed below, if fluid parameters such as density, viscosity, or speed of sound change, the flow meter can be operated using Reynolds number. The flow meter can provide accurate flow measurement when the fluid characteristics change, thereby eliminating the need for procurement and installation of at least one of a costly meter proving device, densitometer, or viscometer. The specific, exemplary and non-limiting embodiments of a turbine flow meter and ultrasonic flow meter are discussed below.

### I. Turbine Flow Meter

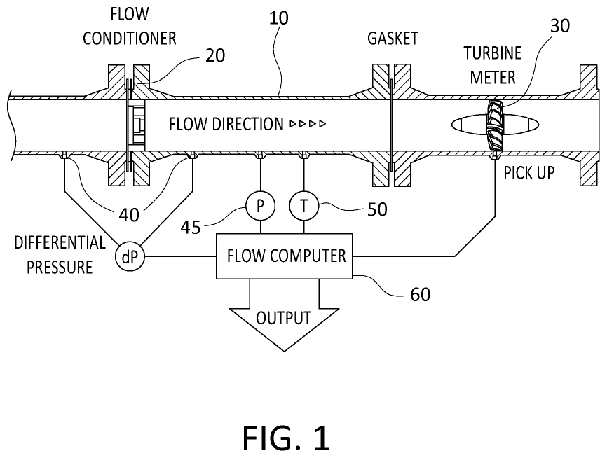

FIG. 1 is a schematic of an exemplary system according to an embodiment of the present invention. A fluid flow pipeline 10 has a flow conditioner or mixer 20 and a downstream turbine flow meter 30. A pair of pressure sensors/transmitters 40 measures the differential pressure on a first and a second side of the flow conditioner or mixer 20. An additional at least one pressure sensor/transmitter 45 measures the pressure of the fluid flow in the pipeline, for example, downstream of the flow conditioner or mixer 20 and upstream of the turbine flow meter 30. At least one temperature sensor/transmitter 50 measures the temperature of the fluid flow in the pipeline.

In an embodiment, at least one flow computer, SCADA equipment/computer, or programmable logic controller (PLC) 60 receives pressure measurements from the pressure sensors/transmitters 40, 45; the at least one temperature sensor/transmitter 50; and velocity or flow rate measurements from the turbine flow meter 30. In embodiments, the flow computer 60 may be connected (e.g., via electrical wires or wirelessly) to any of the sensors/transmitters and to the turbine flow meter.

Hydrocarbon liquid phase flow measurement is a batch-based approach. Per batch, the type of hydrocarbon fluid does not change, but at least one of pressure, temperature, density, viscosity, or flow rate often changes.

Current industry procedure for the measurement of liquid hydrocarbons by a turbine flow meter is dictated by American Petroleum Institute (API) Manual of Petroleum Measurement Standard, Chapter 5.3, ISO 2715, etc. These standards state that a turbine flow meter acts only as a fluid repeatability device. Once a fluid batch session is initiated, a volumetric flow proof is carried out at that particular flowing Reynolds Number.

Currently, a meter proving device provides a “k” factor for the flow meter, which is an adjustment factor to convert the meter-indicated volumetric flow rate to actual volumetric flow rate against actual volumetric flow rate. If the Reynolds number changes (one or more of pressure, temperature, viscosity, density, or flow rate), a new proof must be carried out to provide a new k factor because the k factor is a function of Reynolds Number.

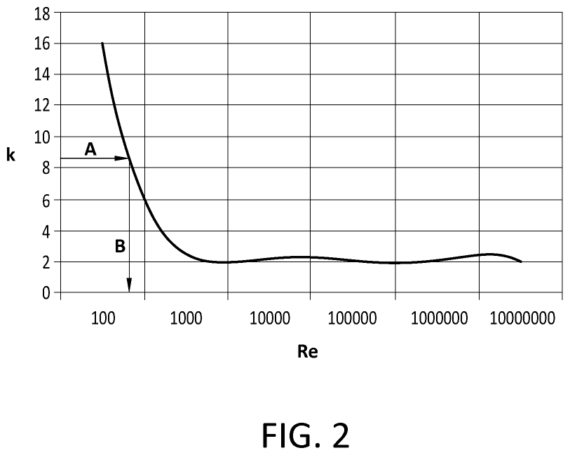

According to the present invention, k factor and Reynolds number data (e.g., a curve, graph, table, or database), for example as shown in FIG. 2, is established for a turbine flow meter for one or more liquids, for example for a plurality of hydrocarbon liquids, using a calibration lab. In embodiments, this turbine flow meter calibration process can be repeated periodically, for example, as per government or company standards (e.g., yearly, every 3 years, every 6 years, or the like).

The turbine flow meter is installed in a fluid flow pipeline. Once a fluid batch has started, volumetric flow rate is measured by the turbine flow meter, along with flow conditioner differential pressure from the pressure sensors/transmitters; pressure from the at least one pressure transmitter; and temperature from the at least one temperature transmitter.

The measured data is sent to the flow computer and/or other Supervisory Control and Data Acquisition (SCADA) equipment. In specific embodiments, the data is collected at predetermined intervals (e.g., once per second, once per minute, or the like) based on variability of the fluid flow. In a specific embodiment, the fluid May optionally be sampled manually and then analyzed in a lab or with local viscometry and/or densitometry equipment. Density and viscosity changes are compared against time. If the effect of these changes causes the volumetric flow measurement to exceed a preset or predetermined volumetric flow error limit, then the time duration between fluid sampling may be adjusted.

According to the present invention, a sample of the flowing fluid is collected, for example via a valve in the pipeline, and is used to measure a standard density, for example, via on-site or lab analysis. In an embodiment, the standard density is measured once after a batch has achieved steady state.

In an embodiment, the measured standard density is converted into actual density utilizing API MPMS 11.1 (American Petroleum Institute Manual of Petroleum Measurement Standard 11.1; the standard is incorporated herein by reference in its entirety) for the flowing pressure measured by the at least one pressure sensor/transmitter and the temperature of the fluid as measured by the at least one temperature sensor.

According to the present invention, the actual density, along with flow conditioner differential pressure, and turbine meter volumetric flow rate are used to calculate a Coefficient of Discharge for the flow conditioner.

Starting from the Orifice Flow Conditioner Equation (1):

$$\dot{V} = {C}_{d} {E}_{v} Y \frac{π}{4} {D}^{2} {β}^{2} \frac{\sqrt{2 ρ Δ P}}{ρ} \qquad Equation ( 1 )$$

| Term | Description |
|---|---|
| \dot{V} | Volumetric Flow Rate from turbine meter (m³/s) |
| C_{d} | Coefficient of discharge (unitless) |
| Eᵥ | Velocity of approach factor (unitless) |
| Y | Expansion factor (Unitless) |
| d | Orifice bore diameter (m) |
| D | Pipe inside diameter (m) |
| ρ | Actual density (kg/m³) |
| ΔP | Differential Pressure (kPa) |
| β | Beta ratio d/D (unitless) |
| \dot{m} | Mass flow rate (kg/s) |

$${C}_{d} = \frac{{\dot{m}}_{Actual}}{{\dot{m}}_{Theoreticd}} ,$$

(Ca is a function of Reynolds Number)

$${E}_{v} = \frac{1}{\sqrt{1 - {β}^{2}}} , β = \frac{d}{D}$$

$$Y = \frac{{Cd}_{compressible}}{{Cd}_{incompressible}} ,$$

Y=1 for liquid phase flow.

Thus, the Coefficient of Discharge (Cd) may be calculated by the following Equation 2:

$${C}_{d} = \frac{4 \dot{V} \sqrt{ρ}}{{E}_{ν} Y π {D}^{2} {β}^{2} \sqrt{2 Δ P}} \qquad ( Equation 2 )$$

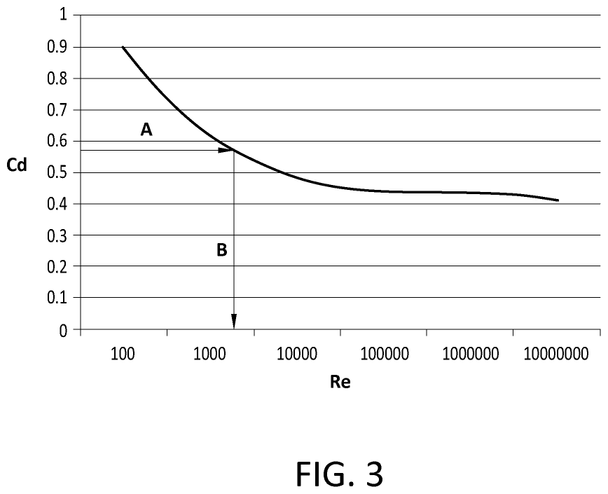

According to an embodiment of the present invention, using the calculated Coefficient of Discharge, the Reynolds number may be obtained from the graph shown in FIG. 3, which was obtained empirically for one more fluids, for example, for a plurality of hydrocarbon fluids.

In another embodiment, using the calculated Coefficient of Discharge, the Reynolds number may be calculated, for example, using American Gas Association (AGA) Flow Measurement Report #3 Orifice Metering of Natural Gas and Other Related Hydrocarbon Fluids, (AGA-3) section 1.7.2 Empirical Coefficient of Discharge Equation for Flange Tapped Orifice Meters, Part 1. This section is incorporated herein by reference in its entirety. In this embodiment, the Reynolds number is iteratively back calculated from the Cd.

Using this empirical or calculated Reynolds number, the k factor may be obtained from the flow meter calibrated k factor and Reynolds number data (e.g., FIG. 2). The actual volumetric flow rate is calculated by k times indicated volumetric flow rate from the turbine flow meter. The Cd is now recalculated using Equation 2 with the k-adjusted actual volumetric flow rate and a new Reynolds number is obtained as discussed above. This process is iteratively repeated until the k factor and Reynolds number do not substantially change, for example, do not change more than 0.01% per iteration.

With this substantially non-changing Reynolds number, the dynamic viscosity of the fluid flow may be calculated (Equation 3) or the kinematic viscosity of the fluid flow may be calculated (Equation 4):

$$Re = \frac{ρ \overline{U} ∅}{μ} \qquad ( Equation 3 )$$

p=density, kg/m³ (actual density as calculated above)
Ū=Mean Velocity, m/s (fluid velocity or flow rate as measured by flow meter)
Ø=Pipe Inside Diameter, m
μ=dynamic viscosity, 0.001 kg/mS, PaS, cp

$$Re = \frac{\overline{U∅}}{γ} \qquad ( Equation 4 )$$

$$γ = kinematic viscosity 1 \times {10}^{- 6} {m}^{2} / s = 1 cSt$$

$$dynamic viscosity μ ( \frac{kg}{ms} ) = kinematic viscosity γ ( {m}^{2} / s ) x ρ ( \frac{kg}{{m}^{3}} )$$

| | | | | | | |
|---|---|---|---|---|---|---|
| 1 | cp | 0.001 | kg/ms | 0.01 | p | 0.001 Pas |
| 1 | cSt | 1 × 10⁻⁶ | m²/s | 0.01 | stokes | |

The viscosity, density, actual pipe velocity or flow rate, and pipe diameter are now known. These quantities may be used to calculate the actual flowing fluid Reynolds number using Equation 3 and/or Equation 4. The k factor for the turbine flow meter at the actual Reynolds number may be used to correct the actual volumetric flow rate to a Reynolds number-corrected flow rate. This process may be repeated until the velocity or flow rate input into the Reynolds number Equations 3 and/or 4 does not substantially change. No on-site meter proofs are required.

In a specific embodiment, the process(es) may be performed using at least one of the flow computer, SCADA equipment/computer, or programmable logic controller (PLC). In embodiments, the k factor as a function of Reynolds number data may be stored in and/or uploaded to at least one of the flow computer, SCADA equipment/computer, or programmable logic controller (PLC).

Over time, data for each fluid batch and/or product type may be recorded, for example, in a database stored in and/or uploaded to at least one of the flow computer, SCADA equipment/computer, or programmable logic controller (PLC). If enough statistically significant data is recorded, sampling of the density may not be required. Rather, using the measured temperature, pressure, and product type, the density may be interpolated off of product-temperature-pressure data.

### II. Liquid Ultrasonic Flow Meter

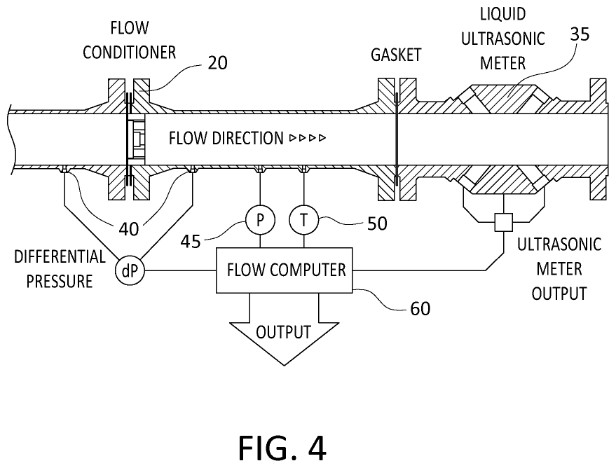

FIG. 4 is a schematic of an exemplary system according to an embodiment of the present invention. The system is essentially the same as that shown in FIG. 1, except for utilizing a liquid ultrasonic flow meter (LUSM) 35.

In the case of a liquid ultrasonic flow meter, a relationship exists between the LUSM speed of sound (SOS) and actual fluid density at pressure and temperature for each fluid composition. This relationship effectively leaves no need to sample density after the initial seeding is completed for each product batch. Seeding is the initial collection of SOS for a fluid by the LUSM. In embodiments, as data of the fluid SOS is collected and saved, it will eventually provide a relationship of a high enough regression coefficient to no longer require sampling.

Hydrocarbon liquid phase flow measurement is a batch-based approach. Per batch, the type of hydrocarbon fluid does not change, but at least one of pressure, temperature, density, viscosity, or flow rate often changes.

As discussed below, for each batch and/or product type, data for an SOS-density relationship at pressure and temperature may be obtained, for example, on-site or at a lab. Eventually enough data will be collected for each product type so that the fluid will not have to be sampled to determine density. In that case, in a specific embodiment, fluid sampling could be used to act as a quality assurance check for density accuracy.

The current industry procedure for the measurement of liquid hydrocarbons by an ultrasonic flow meter is dictated by API, Chapter 5.8, ISO 12242, etc. These standards dictate that the LUSM acts only as a repeatability device. Once a fluid batch session is initiated, an actual volumetric proof is carried out at that particular flowing Reynolds Number.

Currently, a meter proving device provides a “k” factor for the meter which is an adjustment factor to convert the flow-meter indicated volumetric flow rate to actual volumetric flow rate against actual volumetric flow rate. If the fluid Reynolds number changes (e.g., at least one of pressure, temperature, viscosity, density, or flow rate) a new proof must be carried out to provide a new k factor because the k factor is a function of Reynolds number.

According to the present invention, k factor and Reynolds number data (e.g., a curve, graph, table, or database) for a LUSM is established for one or more liquids, for example for a plurality of hydrocarbon liquids, using a calibration lab. In embodiments, this LUSM calibration process can be repeated periodically, for example, as per government or company standard (e.g., yearly, every 3 years, every 6 years, or the like).

The LUSM is installed in a fluid flow pipeline. Once a fluid batch has started, LUSM volumetric flow rate is measured, along with flow conditioner differential pressure, temperature, pressure, and LUSM SOS. The measured data is sent to the flow computer and/or other SCADA equipment. In specific embodiments, the data is collected at predetermined intervals (e.g., once per second, once per minute, or the like) based on variability of the fluid flow.

According to an embodiment, a sample of the flowing fluid is collected, for example via a valve in the pipeline, and is used to measure a standard density, for example, via on-site or lab analysis. In an embodiment, the density is measured once after a batch reaches steady state. The measured standard density is converted into actual density utilizing API MPMS 11.1 for the flowing pressure measured by the at least one pressure sensor/transmitter and a temperature measured by the at least one temperature sensor.

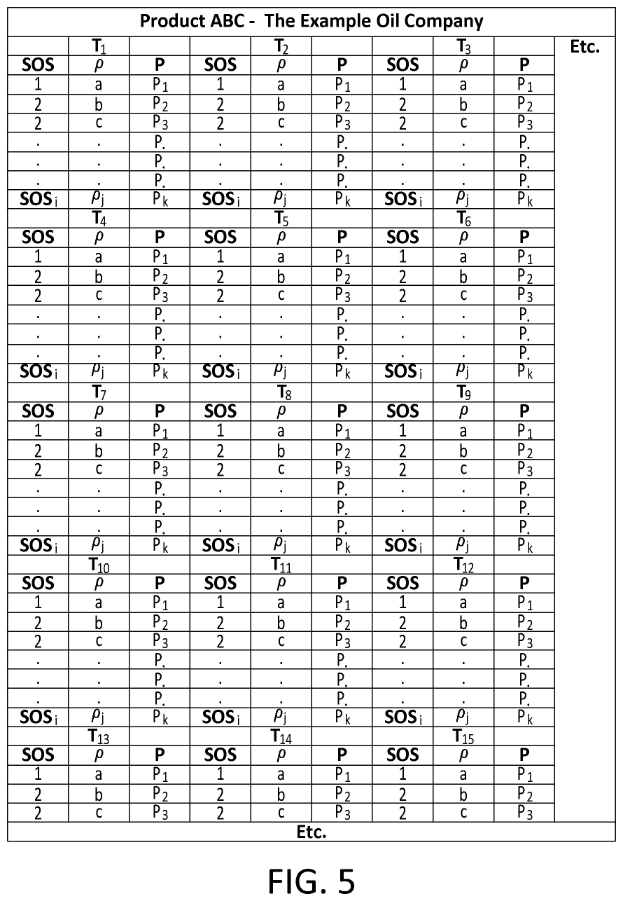

A repeatable and characteristic relationship exists between a substantially non-changing fluid SOS and density at various temperatures and pressures for each fluid type. In an embodiment, this relationship may be modeled by a 4-dimensional surface using Artificial Intelligence or Machine Learning. Alternatively, in specific embodiments as discussed below, an arrangement of SOS, density, pressure, and temperature in one or more databases or thermodynamic tables may be employed, for example, as shown in FIG. 5.

In a specific embodiment, densities are sampled and provided to populate the database/table along with pressure, temperature and SOS, so eventually for each fluid type at any given pressure and temperature a density can be looked up in the one or more databases or thermodynamic tables. Once populated with a sufficiently and a statistically significant level of data, and knowing the temperature and pressure, it may be possible to look up the appropriate density corresponding to a particular SOS.

According to the present invention, the calculated density or the density obtained from a database or table, along with flow conditioner differential pressure, and LUSM flow rate is used to calculate a Coefficient of Discharge for the flow conditioner, using equation (2) as discussed above: 28

$${C}_{d} = \frac{4 \dot{V} \sqrt{ρ}}{{E}_{ν} Y π {D}^{2} {β}^{2} \sqrt{2 Δ P}} \qquad ( Equation 2 )$$

According to the present invention, using the calculated Coefficient of Discharge, the Reynolds number may be calculated, for example, using American Gas Association (AGA) Flow Measurement Report #3 Orifice Metering of Natural Gas and Other Related Hydrocarbon Fluids, (AGA-3) section 1.7.2 Empirical Coefficient of Discharge Equation for Flange Tapped Orifice Meters, Part 1. In this embodiment, the Reynolds number is iteratively back calculated from the Cd.

Using this calculated Reynolds number, the k factor may be obtained from the flow meter calibrated k factor as a function of Reynolds number data (e.g., like FIG. 2 but for a LUSM). The actual volumetric flow rate is calculated by k times indicated volumetric flow rate from the LUSM. The Cd is now recalculated using Equation 2 with the k-adjusted actual volumetric flow rate and a new Reynolds number. This process is iteratively repeated until the k factor and the Reynolds number do not substantially change, for example, do not change more than 0.01% per iteration.

With this substantially non-changing Reynolds number, the dynamic viscosity May be calculated (Equation 3) or the kinematic viscosity may be calculated (Equation 4), as discussed above.

The viscosity, density, actual pipe flow rate or velocity, and pipe diameter are now known. These quantities may be used to calculate the actual flowing fluid Reynolds number using Equations 3 and/or 4. The k factor for the LUSM at the actual Reynolds number may be used to correct the actual volumetric flow rate to a Reynolds number-corrected flow rate. This process may be repeated until the velocity or flow rate input into the Reynolds number Equations 3 and/or 4 does not substantially change. No on-site meter proofs are required.

In a specific embodiment, the process(es) may be performed using at least one of the flow computer, SCADA equipment/computer, or programmable logic controller (PLC). In embodiments, the k factor as a function of Reynolds number data, and the one or more databases or thermodynamic tables may be stored in and/or uploaded to at least one of the flow computer, SCADA equipment/computer, or programmable logic controller (PLC).

### III. Flow Conditioners or Mixer

The flow conditioner may be a single plate or disk with a plurality of holes (e.g., one or more concentric rings of holes). In embodiment, the flow conditioner may be a unitary integral structure, not made from tube bundles, and does not have any fins or projections extending from a front or back surface thereof.

In specific embodiments, the at least one flow conditioner may be, but is not limited to, CPA TBR, CPA 50E, CPA 55ER, CPA 60ER, CPA 65ER flow conditioners, available from Canada Pipeline Accessories, Inc. (CPA) of Calgary, Canada. In a specific embodiment, a mixer may be at least one static mixer, including but not limited to, one or more mixers from the CPA Flo2Gether line of static mixers.

### INDUSTRIAL APPLICABILITY

The present invention is directed to a system and methods for operating a flow meter in a fluid pipeline without the need for at least one of a meter proving device, a viscometer, or a densitometer. In particular, the present invention applies to systems utilizing volumetric flow meters, for example, a turbine flow meter or an ultrasonic flow meter.

Although the present invention has been described in terms of particular exemplary and alternative embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the exemplary and alternative embodiments described above can be configured without departing from the scope and spirit of the invention. Therefore, it is to be understood that, within the scope of the appended claims, the invention may be practiced other than as specifically described herein.

1. A system, comprising:
at least one flow conditioner or mixer installed in a pipeline;
at least one flow meter installed downstream from the at least one flow conditioner or mixer that measures a flow rate of a fluid in the pipeline;
a pair of pressure sensors or transmitters, one pressure sensor or transmitter located at or near a first side of the least one flow conditioner or mixer, and another pressure sensor or transmitter located at or near a second side of the least one flow conditioner or mixer, thereby measuring a differential pressure of the at least one flow conditioner or mixer;
at least one further pressure sensor or transmitter that measures a fluid pressure in the pipeline; and
at least one temperature sensor for measuring a fluid temperature in the pipeline,
wherein the at least one flow meter is calibrated for a plurality of fluids to obtain k factor as a function of Reynolds number data.

2. The system according to claim 1, wherein the flow meter is a turbine flow meter.

3. The system according to claim 1, wherein the flow meter is an ultrasonic flow meter.

4. The system according to claim 1, comprising at least one flow conditioner.

5. The system according to claim 1, wherein the system does not comprise a flow meter proving device.

6. The system according to claim 1, wherein the system does not comprise a viscometer.

7. The system according to claim 1, wherein the k factor and Reynolds number data are stored in and/or uploaded to at least one of a flow computer, SCADA equipment/computer, or a programmable logic controller (PLC).

8. A method, comprising:
measuring a differential pressure of a fluid on a first and on a second side of at least one flow conditioner or mixer installed in a pipeline by a pair of pressure sensors or transmitters, one pressure sensor or transmitter located at or near a first side of the least one flow conditioner or mixer, and another pressure sensor or transmitter located at or near a second side of the least one flow conditioner or mixer;
measuring a temperature of the fluid in the pipeline with at least one temperature sensor;
measuring a pressure of the fluid in the pipeline by a further pressure sensor or transmitter;
measuring flow rate the fluid with a flow meter downstream of the at least one flow conditioner or mixer, wherein the flow meter is calibrated for a plurality of fluids to obtain k factor as a function of Reynolds number data; and
measuring or obtaining a density of the fluid.

9. The method according to claim 8, wherein the flow meter is a turbine flow meter.

10. The method according to claim 9, further comprising converting a measured density of the fluid into actual density.

11. The method according to claim 10, further comprising calculating a Coefficient of Discharge for the at least one flow conditioner.

12. The method according to claim 11, further comprising obtaining or calculating a Reynoldvs number of the fluid from the Coefficient of Discharge.

13. The method according to claim 12, further comprising:
for the calculated Reynolds number, obtaining a corresponding k factor from the k factor as a function of Reynolds number data; and
calculating the actual volumetric flow rate using the k factor.

14. The method according to claim 13, further comprising:
using the k-adjusted actual volumetric flow rate, recalculating the Coefficient of Discharge;
calculating a second Reynolds number and obtaining a second k factor; and
repeating the method until the Reynolds number and the k factor do not substantially change.

15. The method according to claim 14, further comprising calculating viscosity of the fluid based on the substantially non-changing Reynolds number.

16. The method according to claim 15, further comprising:
calculating the actual flowing fluid Reynolds number based on the calculated viscosity, actual density, pipe diameter, and actual volumetric flow rate;
using a k factor, correcting the actual volumetric flow rate to a Reynolds number-corrected flow rate; and
repeating the method until the actual volumetric flow rate does not substantially change.

17. The method according to claim 8, wherein the flow meter is a liquid ultrasonic flow meter.

18. The method according to claim 17, comprising obtaining a density from a database or thermodynamic table comprising density as a function of temperature, pressure, and speed of sound for a plurality of hydrocarbon fluids.

19. The method according to claim 18, further comprising calculating a Coefficient of Discharge for the at least one flow conditioner.

20. The method according to claim 19, further comprising calculating a Reynolds number of the fluid from the Coefficient of Discharge.

21. The method according to claim 20, further comprising:
for the calculated Reynolds number, obtaining a corresponding k factor for the flow meter from the k factor as a function of Reynolds number data; and
calculating the actual volumetric flow rate using the k factor.

22. The method according to claim 21, further comprising:
using the k-adjusted actual volumetric flow rate, recalculating the Coefficient of Discharge;
calculating a second Reynolds number and obtaining a second k factor; and
repeating the method until the Reynolds number and the k factor do not substantially change.

23. The method according to claim 22, further comprising calculating viscosity of the fluid based on the substantially non-changing Reynolds number.

24. The method according to claim 23, further comprising:
calculating the actual flowing fluid Reynolds number based on the calculated viscosity, actual density, pipe diameter, and actual volumetric flow rate;
using a k factor, correcting the actual volumetric flow rate to a Reynolds number-corrected flow rate; and
repeating the method until the actual volumetric flow rate does not substantially change.

25. A system, comprising:
at least one flow conditioner or mixer installed in a pipeline;
at least one flow meter installed downstream from the at least one flow conditioner or mixer that measures a flow rate of a fluid in the pipeline;
a pair pressure sensors or transmitters, one pressure sensor or transmitter located at or near a first side of the least one flow conditioner or mixer, and another pressure sensor or transmitter located at or near a second side of the least one flow conditioner or mixer, thereby measuring a differential pressure of the at least one flow conditioner or mixer;
at least one further pressure sensor or transmitter that measures a fluid pressure in the pipeline;
at least one temperature for measuring a fluid temperature in the pipeline, and
at least one of a flow computer, SCADA equipment, programmable logic controller, or any combination thereof configured to perform the method of claim 8.
